(19) United States
(12) Patent Application Publication
(10) Pub. No.: US 2013/0159402 A1
(43) Pub. Date: Jun. 20, 2013

(54) SOCIAL ASPECTS FOR DATA COLLABORATION

(71) Applicants: Christian Liensberger, Bellevue, WA (US); Rene Bouw, Kirkland, WA (US); Lukasz Gwozdz, Issaquah, WA (US)

(72) Inventors: Christian Liensberger, Bellevue, WA (US); Rene Bouw, Kirkland, WA (US); Lukasz Gwozdz, Issaquah, WA (US)

(73) Assignee: MICROSOFT CORPORATION, Redmond, WA (US)

(21) Appl. No.: 13/325,867

(22) Filed: Dec. 14, 2011

(51) Int. Cl. G06F 15/16

(52) U.S. Cl. 709/204

(57) ABSTRACT

Methods, systems, and computer program products are provided for enabling users to enhance datasets available at a data service. A data service maintains and publishes datasets provided by content providers. Users may be enabled to annotate datasets maintained by the data service, and to extend the datasets. A suggestion of a dataset may be provided to users based on information received from a community of users. Users may be enabled to generate assets, such as reports and applications, based on one or more datasets of the data service. Furthermore, users may be enabled to share annotated datasets and/or extended datasets in websites, applications, and devices.

### BACKGROUND

Data services exist that enable content providers to publish data and share it with a broad number of users. Users of a data service may be enabled to discover data, purchase data, and use the discovered/purchased data. An example of such a data service is Windows Azure™ Marketplace DataMarket developed by Microsoft Corporation of Redmond, Wash.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for enabling users to enhance data services and datasets available at data services. A data service maintains and publishes datasets provided by content providers. According to one method implementation, users may be enabled to annotate datasets maintained by a data service, and to extend the datasets. Users may further be enabled to comment on datasets, including annotated and/or extended datasets. The users may be enabled to annotate, extend, and/or comment on any portions of the datasets, including a column or row of a dataset, a table of a dataset, and/or a dataset in its entirety. Furthermore, datasets of the data service may be suggested to users based on information received from a community of users that utilize the data service. Users may be enabled to generate assets, such as reports and applications, based on one or more datasets of the data service. Furthermore, users may be enabled to share annotated datasets and/or extended datasets in websites, applications, and/or devices.

In a system implementation, a server includes a provider interface module and an annotation and extension system. The provider interface module enables content providers to provide datasets to be maintained by a data service. The data service publishes and shares the datasets with users of the data service. The annotation and extension system enables a community of users to annotate and extend the datasets maintained by the data service. The annotation and extension system includes a dataset annotation module, a dataset extension module, and a suggestion interface module. The dataset annotation module enables a first user to annotate a first dataset maintained by the data service. The dataset extension module enables the first user to extend the first dataset. The suggestion interface module generates a suggestion of a second dataset to the first user based on information received from a community of users.

The annotation and extension system may further include an asset generator module that enables the first user to generate an asset based at least on the first dataset. Still further, the annotation and extension system may include a dataset share module that enables the first user to share the annotated first dataset and/or the extended first dataset in a website, an application, and/or a device.

Computer program products containing computer readable storage media are also described herein for enabling users to annotate and/or extend datasets of a data service, to comment on annotated and/or extended datasets, to suggest datasets of a data service, to generate assets from datasets of a data service, and to share datasets of a data service, as well as for additional embodiments.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a data service environment, according to an example embodiment.

FIG. 2 shows a block diagram of an annotation and extension system for a data service, according to an example embodiment.

FIG. 3 shows a flowchart providing a process for enhancing datasets of a data service, according to an example embodiment.

FIG. 4 shows a block diagram of a dataset annotation module, according to an example embodiment.

FIG. 5 shows a block diagram of a computing device that displays a user interface for interacting with a data service, according to an example embodiment.

FIG. 6 shows a flowchart providing a process for enabling users to annotate datasets, according to an example embodiment.

FIG. 7 shows a block diagram of a dataset extension module, according to an example embodiment.

FIG. 8 shows a flowchart providing a process for enabling users to extend datasets, according to an example embodiment.

FIG. 9 shows a block diagram of a suggestion interface module, according to an example embodiment.

FIG. 10 shows a flowchart providing a process for enabling datasets to be suggested, according to an example embodiment.

FIG. 11 shows a block diagram of an asset generator module, according to an example embodiment.

FIG. 12 shows a flowchart providing a process for enabling users to generate assets based on datasets, according to an example embodiment.

FIG. 13 shows a block diagram of a dataset share module, according to an example embodiment.

FIG. 14 shows a flowchart providing a process for enabling users to share datasets, according to an example embodiment.

FIG. 15 shows a block diagram of an example computer that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments of the present invention are described as follows. It noted that any section/subsection headings provided herein are not intended to be limiting. Embodiments are described throughout this document, and any type of embodiment may be included under any section/subsection.

### II. Example Embodiments

Embodiments relate to network accessible data services. A data service enables content providers to publish their data in the form of datasets. An example of such a data service is Windows Azure™ Marketplace DataMarket developed by Microsoft Corporation of Redmond, Wash. A dataset may include any quantity and format of data, including sets of data having the form of tables that includes rows and columns of data. Any type of data may be included in a dataset, including numerical data (e.g., integers, real numbers, etc.), alphanumerical data (e.g., strings), and further types of data. Content providers may be entities (e.g., individuals, companies, etc.) that generate and/or otherwise provide data to the data service. The content providers provide their data to the data service so that their data may be found, purchased or otherwise monetized, and/or used by users. Users of a data service are enabled to discover data, purchase data, and use the discovered/purchased data in their applications. For example, a data service may include a marketplace, in which users may purchase access to selected datasets by interacting with a purchase interface.

Furthermore, according to embodiments, users are enabled to annotate datasets, extend datasets, share datasets, generate assets based on datasets, provide comments on datasets, and perform further functions and enhancements with regard to datasets of a data service. Such embodiments enable users to share data insights and collaborate on data of a data service with other persons such as friends, co-workers, and others, and on various platforms such as anonymous networks and social networks.

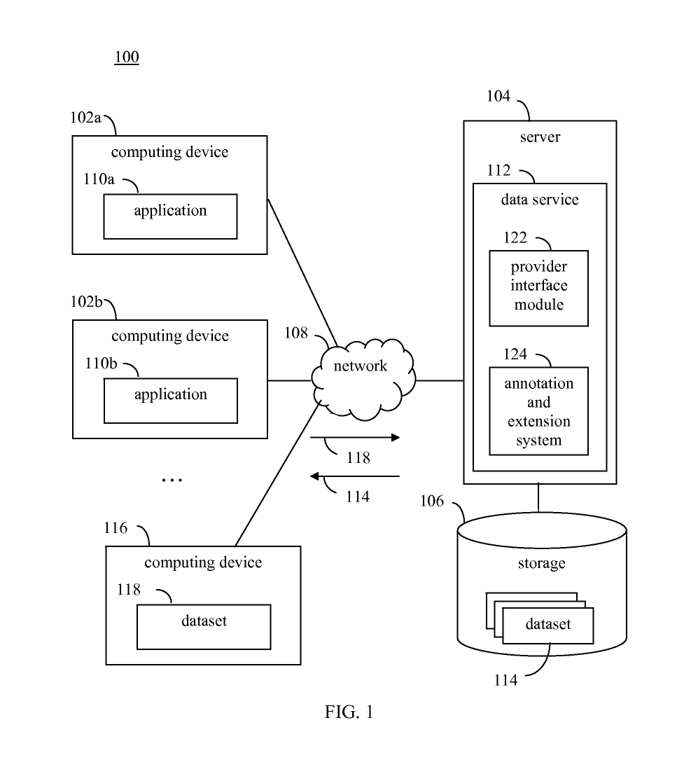

Such embodiments may be implemented in a variety of environments. For instance, FIG. 1 shows a block diagram of a data service environment, according to an example embodiment. As shown in FIG. 1, environment 100 includes first and second computing devices 102a and 102b, a server 104, storage 106, a network 108, and a computing device 116. As shown in FIG. 1, computing devices 102a and 102b include applications 110a and 110b, respectively, and server 104 includes a data service 122. Data service 112 includes a provider interface module 122 and an annotation and extension system 124. Environment 100 is described as follows.

Computing device 102a, 102b, and 116 may each be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a mobile phone (e.g., a cell phone, a smart phone such as an Apple iPhone, a Google Android™ phone, a Microsoft Windows® phone, etc.), or other type of mobile device. Server 104 may be implemented in one or more computer systems, including one or more servers, which may be any type of computing device described herein or otherwise known that is capable of enabling the corresponding functionality described herein.

Computing devices 102a, 102b, and 116, and server 104 are communicatively coupled by network 108. Network 108 may include one or more communication links and/or communication networks, such as a PAN (personal area network), a LAN (local area network), a WAN (wide area network), or a combination of networks, such as the Internet. Computing devices 102a, 102b, and 116, and server 104 may be communicatively coupled to network 108 using various links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc.

Two computing devices 102a and 102b and one computing device 116 are shown in FIG. 1 for purposes of illustration. However, any number of computing devices 102 and 116 may be present in environment 100, including tens, hundreds, thousands, and even greater numbers of computing devices 102 and 116. Each computing device 102 may operate one or more corresponding applications 110.

As shown in FIG. 1, storage 106 is coupled to computing device 102. Storage 106 stores datasets 114. Storage 106 may have the format of a database or other format, and may include one or more of any type of storage mechanism to store datasets 114, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Computing device 116 is a computing device of a content provider. The content provider uses computing device 116 to provide datasets of the content provider, such as a dataset 118, to data service 112 to be accessible by users. For example, as shown in FIG. 1, computing device 116 may interact with a provider interface generated by provider interface module 122 of data service 112. For instance, provider interface module 122 may generate a graphical user interface (GUI), may provide a web service interface, and/or may provide other interface that enables content providers to provide datasets to data service 112. In one embodiment, a user (e.g., a content provider) at computing device 116 may interact with a web browser to access a web page provided by provider interface module 112, which can be used to upload dataset 118 to data service 112. In other embodiments, dataset 118 may be provided to data service 112 in other ways. Furthermore, the content provider may provide a description, a title, a logo, a dataset category, and/or may provide other identifying information for dataset 118. As shown in FIG. 1, computing device 116 may transmit dataset 118 in a communication signal through network 108 to be received by provider interface module 122 of data service 112 at server 104. The communication signal may be transmitted in any form. Dataset 118 may be stored in storage 106 by data service 112 as dataset 114 or other stored dataset.

Computing devices 102a and 102b are computing devices of users that may desire to locate data, purchase/lease data, annotate data, extend data, and/or otherwise interact with data provided by data service 112. Annotation and extension system 124 of data service 112 enables datasets of storage 106 to be accessed by users at computing devices 102a and 102b. For instance, annotation and extension system 124 may enable users to annotate datasets of data service 112, to extend datasets of data service 112, to share datasets of data service 112, and/or to otherwise interact with datasets of data service 112. Users at computing devices 102a and 102b may interact with the datasets of data service 112 in any manner, and may use the datasets in any manner, such as by using datasets in applications 110a and 110b. Applications 110a and 110b are software applications that execute/operate in computing devices 102a and 102b. For example, applications 110a and 110b may each be an office suite application, desktop application, mobile application, web application, etc. Office suite applications include various types of productivity enhancing applications, such as word processing applications, spreadsheet applications, presentation applications, etc. Desktop applications include various types of applications that configured to operate in computer desktops (e.g., of desktop computers), including some office suite applications, desktop widgets or gadgets (interactive tools that typically provide single purpose services, such as news streaming, providing the current weather, showing current stock quotes, etc.), etc. Mobile applications include various types of applications (e.g., “Apps”) that operate in mobile, handheld devices such as smart phones, tablet computers, portable media players, personal digital assistants (PDAs), etc. Web applications (also known as a “web apps” or “webapps”) are applications that are accessible over a network such as the Internet or an intranet, and may be hosted in a web browser that renders the application. Example applications include social networking applications, navigational assistance applications (e.g., mapping applications, restaurant locating applications, traffic applications, etc.), gaming applications, financial planning applications, etc.

For instance, as shown in FIG. 1, a user at computing device 102a (and/or a user at computing device 102b) may interact with an interface provided by annotation and extension system 124 (e.g., a graphical user interface, a web service interface, etc.) to interact with datasets of data service 112, and to download datasets from data service 112. As shown in FIG. 1, dataset 114 may be transmitted from data service 112 of server 104 in a communication signal through network 108 to be received by computing device 102a. The communication signal may be transmitted in any form. Dataset 114 may be used in application 110a and/or consumed in any other manner at computing device 102a. Note that the user of computing device 102a may have a user account associated with data service 112 to enable the user to access datasets at data service 112, or may be authorized to access the datasets in other manner. The user may interact with a user interface provided by annotation and extension system 124 to purchase datasets, to subscribe to datasets, to lease datasets, and/or to otherwise provide compensation for accessing datasets. Furthermore, as described as follows, the user may interact with a user interface provided by annotation and extension system 124 to annotate datasets, extend datasets, share datasets, generate assets based on datasets, provide comments on datasets, and/or perform other functions with regard to datasets of data service 112.

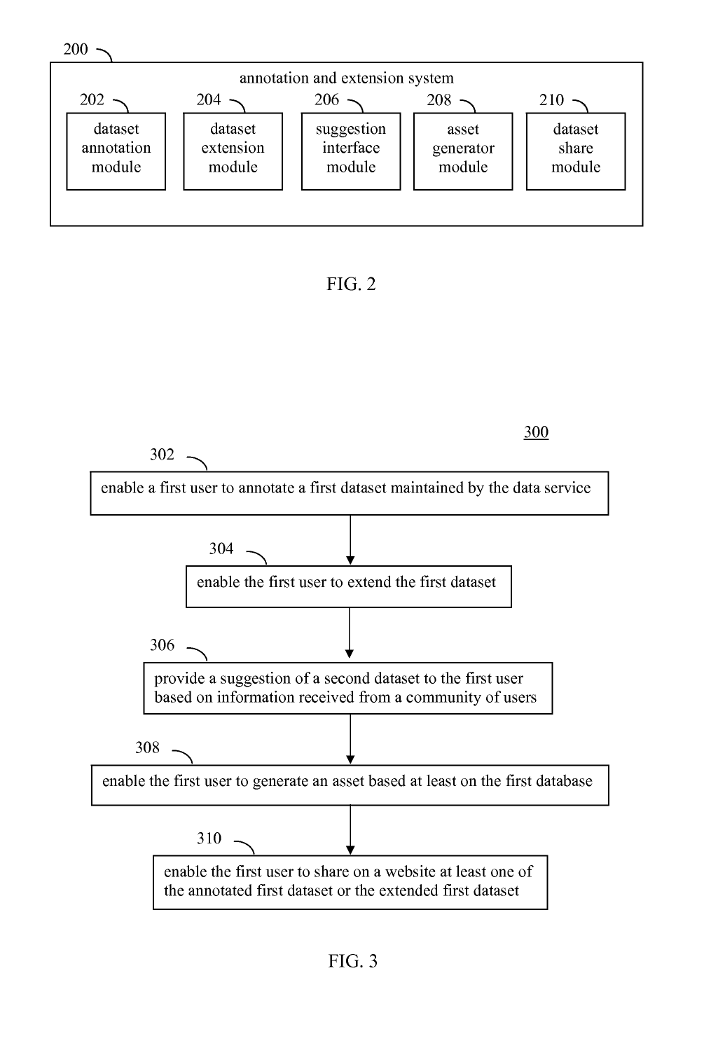

For instance, FIG. 2 shows a block diagram of an annotation and extension system 200, according to an example embodiment. Annotation and extension system 200 is an example of annotation and extension system 124 of FIG. 1. As shown in FIG. 2, annotation and extension system 200 includes a dataset annotation module 202, a dataset extension module 204, a suggestion interface module 206, an asset generator module 208, and a dataset share module 210. Annotation and extension system 200 of FIG. 2 is configured to enable users to annotate, datasets, extend datasets, share datasets, generate assets based on datasets, provide comments on datasets, and perform further functions with regard to datasets of data service 112. Note that any one or more of dataset annotation module 202, dataset extension module 204, suggestion interface module 206, asset generator module 208, and dataset share module 210 may be present in annotation and extension system 200, in embodiments.

Annotation and extension system 200 of FIG. 2 may operate in various ways to perform its functions. For instance, FIG. 3 shows a flowchart providing a process for annotating and/or extending datasets of a data service, according to an example embodiment. Flowchart 300 is described as follows with reference to FIG. 2. Further structural and operational embodiments will be apparent to persons skilled in the relevant art(s) based on the following discussion regarding flowchart 300.

Flowchart 300 begins with step 302. In step 302, a first user is enabled to annotate a first dataset maintained by the data service. For instance, in an embodiment, dataset annotation module 202 enables users to annotate datasets, such as dataset 114, of data service 112 of FIG. 1. According to embodiments, dataset annotation module 202 may be configured to enable users to annotate metadata of datasets, including enabling users of a community of users to provide annotations for various components of the metadata, to collaborate on annotations, to comment on annotations, and to annotate datasets in further ways. Further embodiments for annotating datasets are described below.

In step 304, the first user is enabled to extend the first dataset. For instance, in an embodiment, dataset extension module 204 enables users to extend datasets, such as dataset 114, of data service 112 of FIG. 1. According to embodiments, dataset extension module 204 may be configured to enable users to extend the schema of datasets of a data service, to create new datasets, to establish new relationships between entities and datasets, to combine datasets into one logical unit, to expose extensions to community to ratings, and to let users feed the new dataset models back to into the data service marketplace. Further embodiments for extending datasets are described below.

In step 306, a suggestion of a second dataset is provided to the first user based on information received from a community of users. For example, in an embodiment, suggestion interface module 206 provides suggestions of datasets to users based on information received from a community of users that interact with data service 112 of FIG. 1. According to embodiments, suggestion interface module 206 may be configured to enable users to suggest relevant datasets to other users, to provide a user with a selection of datasets that might also be interesting for the user based on dataset selections made by the community of users, to let users of the community combine dataset into bundles, and to provide suggestions of what datasets fit together. Further embodiments for enabling suggestions to be provided on datasets are described below.

In step 308, the first user is enabled to generate an asset based at least on the first database. For instance, in an embodiment, asset generator module 208 enables users to generate assets based on datasets, such as dataset 114, of data service 112 of FIG. 1. According to embodiments, asset generator module 208 may be configured to enable users to create derived assets from existing datasets of a data service, such as by building reports, visualizations, and/or applications on top of datasets, sharing them with the user community, and enabling users take the derivative assets and use them as starting points to which to add their own knowledge. Further embodiments for enabling assets to be generated based on datasets are described below.

In step 310, the first user is enabled to share on a website at least one of the annotated first dataset or the extended first dataset. For example, in an embodiment, dataset share module 210 enables users to share datasets, including their annotated and/or extended datasets, with other users by placing them on websites. According to embodiments, dataset share module 210 may be configured to enable users to share insights regarding datasets with co-workers and friends on social networks, and on the Internet through posting datasets on websites. Dataset share module 210 may also be configured to enable users to share datasets in applications and devices. Further embodiments for enabling sharing of datasets are described below.

Annotation and extension system 200 of FIG. 2 and the components included therein may perform their functions in various ways, and may be configured in various ways, in embodiments. Numerous exemplary embodiments for each of the components of annotation and extension system 200 and further embodiments for annotating and extending datasets are described in the following subsections.

### A. Example Embodiments for Annotation of Datasets

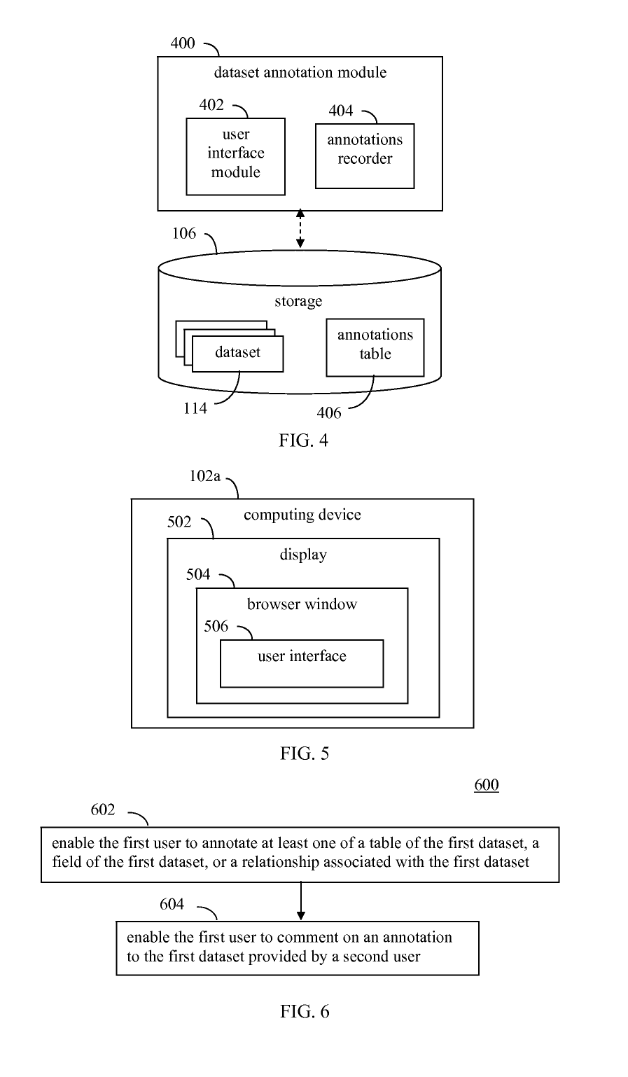

According to an example embodiment, users are enabled to annotate datasets of a data service. For example, FIG. 4 shows a block diagram of a dataset annotation module 400, according to an example embodiment. Dataset annotation module 400 is an example of dataset annotation module 202 of FIG. 2. As shown in FIG. 4, dataset annotation module 400 includes a user interface module 402 and an annotations recorder 404. Furthermore, dataset annotation module 400 is coupled to storage 106. Storage 106 stores a plurality of datasets, including dataset 114, and an annotations table 406.

User interface module 402 is configured to generate a user interface that enables users to interact with dataset annotation module 400 to annotate datasets, such as dataset 114. Annotations recorder 404 is configured to record the annotations to datasets that are made through the user interface. For instance, annotations recorder 404 may generate and maintain annotations table 406. Annotations table 406 may be a file or other stored object that stores the annotations to datasets. Annotations table 406 may have the form of one or more tables, arrays, or other data structures.

In an embodiment, user interface module 402 may generate a textual interface, a graphical user interface (GUI), or other user interface that users may interact with at a computing device (e.g., computing devices 102a and 102b of FIG. 1). For instance, FIG. 5 shows a block diagram of computing device 102a having a display 502 that displays a user interface 506 for interacting with a data service, according to an example embodiment. As shown in FIG. 5, user interface 506 may be displayed in a browser window 504 generated by a web browser, although in other embodiments, a user interface may be generated using a different tool at computing device 102a. In one embodiment, user interface module 402 may generate a web page that may be viewed in browser window 504 at computing device 102a, and may be interacted with by a user of computing device 102a. The web page or other user interface may provide one or more user interface elements (e.g., text boxes, pull down windows, pop-up menus, etc.) with which a user may interact to annotate a dataset. In the example of FIG. 5, user interface 506 may be generated in browser window 504 from suitable page code (e.g., HTML, XML, or other browser suitable language) or in other manner.

Display 502 may be any suitable type of display device having a display screen, such as a cathode ray tube (CRT) display, a liquid crystal display (LCD) display, a light emitting diode (LED) display, a plasma display, or other display type. Browser window 504 is a window generated by a web browser operating in computing device 102a, such as Internet Explorer®, developed by Microsoft Corp. of Redmond, Wash., Mozilla Firefox®, developed by Mozilla Corp. of Mountain View, Calif., Google® Chrome developed by Google Inc. of Mountain View, Calif.

Dataset annotation module 400 may operate in various ways to enable users to annotate datasets. For instance, FIG. 6 shows a flowchart 600 providing a process for enabling users to annotate datasets, according to an example embodiment. Flowchart 600 may be performed by dataset annotation module 400 of FIG. 4, and may be performed during step 302 of flowchart 300 (FIG. 3), in an embodiment. Not all steps of flowchart 600 need to be performed in all embodiments. Further structural and operational embodiments will be apparent to persons skilled in the relevant art(s) based on the following discussion regarding flowchart 600.

Flowchart 600 begins with step 602. In step 602, the first user is enabled to annotate at least one of a table of the first dataset, a field of the first dataset, or a relationship associated with the first dataset. For example, in an embodiment, a user (e.g., a user of computing device 102a) may be enabled to annotate metadata of a dataset in any manner, including annotating one or more tables of a dataset, one or more fields/columns in a table of a dataset, one or more relationships within a table of a dataset or between different tables (of one or more datasets), etc. The user may interact with a user interface generated by user interface module 402 (e.g., user interface 506) to provide the annotations, and annotations recorder 404 may incorporate the annotations in annotations table 406. As such, annotations table 406 may indicate any number of annotations to datasets, including annotations to tables of a dataset, fields of a dataset, relationships of dataset(s), etc. Furthermore, by maintaining the annotations separately from the datasets, the annotations are not permanently associated with the datasets. Annotations may optionally be made permanently associated with a dataset by being merged with the dataset, if desired. The annotations may be recorded in annotations table 406 by annotation recorder 404.

Any number and type of annotations may be made to metadata of a dataset. Examples of annotations include setting semantic annotations on fields/properties of a dataset, describing fields (e.g., “this column is an address column”), describing tables (e.g., “this table is a sales data table”), referring to known taxonomies, describing relationships between datasets (e.g., “this dataset and dataset Z may be used together”), describing relationships between tables, etc. Annotations may include new information or may include alternative/additional information to information that was originally added for a dataset by a content provider, to better describe the dataset (e.g., an alternative title, one or more additional categories for the dataset, additional description of the dataset, etc.). Annotations may be made in human readable textual form and/or in other forms. Annotations may be made to describe fields, properties, tables, other portions of a dataset, entire datasets, etc. so that they may be better understandable to users and/or for other reasons. Single users may be enabled to make an annotation to a dataset, and multiple users of a community of users may be enabled to collaborate on an annotation to a dataset and to make annotations on annotations (e.g., layers of annotations).

Referring back to flowchart 600 of FIG. 6, in step 604, the first user is enabled to comment on an annotation to the first dataset provided by a second user. For example, in an embodiment, a first user (e.g., a user of computing device 102a) may be enabled to comment on an annotation to a dataset made by a second, different user (e.g., a user of computing device 102b). The first user may interact with a user interface generated by user interface module 402 (e.g., user interface 506) to provide the comment. Any number and type of comments may be made on an annotation. Examples of types of comments include textual comments, rating an annotation (e.g., rating in the range of 1-10 or other range, a textual rating such as “this annotation is useful” or “this annotation is not accurate”, a rating range of “good”, “satisfactory”, “bad”, or other textual rating, etc.), voting up or down on an annotation, commenting “like” or “unlike”, voting whether an annotation is an official annotation, etc. The comments on the annotations may be recorded in annotations table 406 by annotation recorder 404.

For example, an annotation may be ranked or voted on whether it is an official view (e.g., highly accepted by all users), whether it is widely accepted (e.g., accepted by most users), whether it is a community view (e.g., that is accepted by a designated subset of all users), or whether it is a controversial view (e.g., accepted by relatively few users of the user community). Such comments on annotation may be viewed in various ways in a user interface. For instance, in an embodiment, a user interface element of a slider bar may be slid back and forth between views—e.g., an “official view” to a “widely accepted/suggested view” to a “community view” to a “controversial view.” Depending on which view is selected by the position of the slider, the corresponding comments on annotations are made visible (and others are made non-visible), as they have been ranked by users.

### B. Example Embodiments for Extending Datasets

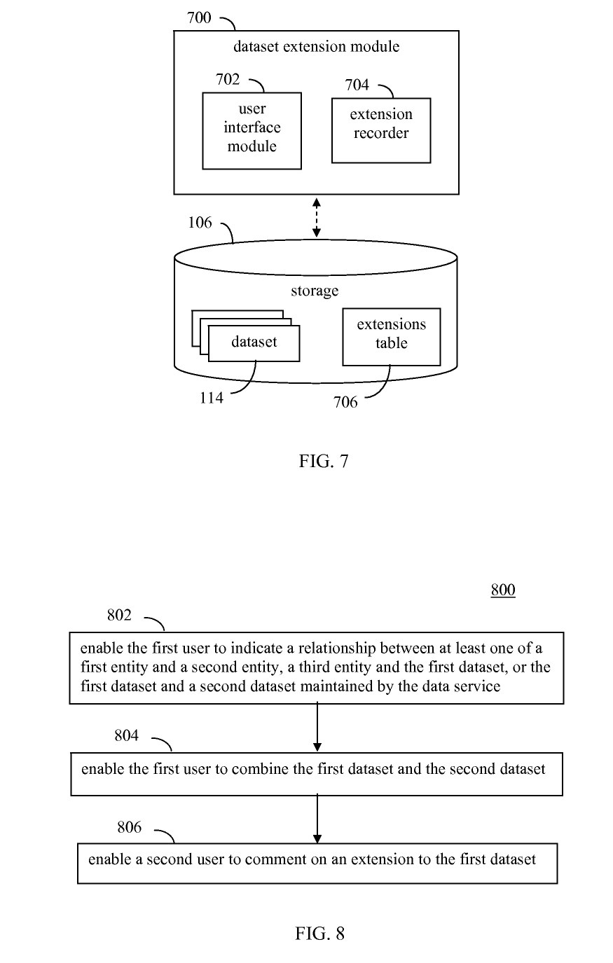

According to an example embodiment, users are enabled to extend datasets of a data service. For example, FIG. 7 shows a block diagram of a dataset extension module 700, according to an example embodiment. Dataset extension module 700 is an example of dataset extension module 204 of FIG. 2. As shown in FIG. 7, dataset extension module 700 includes a user interface module 702 and an extension recorder 704. Furthermore, dataset extension module 700 is coupled to storage 106. Storage 106 stores a plurality of datasets, including dataset 114, and an extensions table 706.

User interface module 702 is configured to generate a user interface that enables users to interact with dataset extension module 700 to extend datasets, such as dataset 114. An example of such a user interface is user interface 506 shown in FIG. 5 and described above, as well as other user interfaces described elsewhere herein. Extension recorder 704 is configured to record the extensions to datasets made using the user interface in extensions table 706. For example, crime data may be maintained in a crime dataset table that includes city and state columns for crime locations. It may be desired to extend the crime dataset by adding a latitude column and a longitude column to provide latitude and longitude location information for crimes (e.g., that may be used to visualize crime activity on a map). A user may interact with the user interface to extend the crime dataset in this manner, and extension recorder 704 may record this extension to the crime dataset in extensions table 706. For instance, extension recorder 704 may generate and maintain extensions table 706. Extensions table 706 may be a file or other stored object that stores extensions to datasets. Extensions table 706 may have the form of one or more tables, arrays, or other data structures. By maintaining the extensions separately from the datasets, the extensions are not permanently incorporated in the datasets. Extensions may optionally be made permanently associated with a dataset by being merged with the dataset, if desired

Dataset extension module 700 may operate in various ways to enable users to extend datasets. For instance, FIG. 8 shows a flowchart 800 providing a process for enabling users to extend datasets, according to an example embodiment. Flowchart 800 may be performed by dataset extension module 700 of FIG. 7, and may be performed during step 304 of flowchart 300 (FIG. 3), in an embodiment. Not all steps of flowchart 800 need be performed in all embodiments. Further structural and operational embodiments will be apparent to persons skilled in the relevant art(s) based on the following discussion regarding flowchart 800.

Flowchart 800 begins with step 802. In step 802, the first user is enabled to indicate a relationship between at least one of a first entity and a second entity, a third entity and the first dataset, or the first dataset and a second dataset maintained by the data service. For example, in one embodiment, datasets may be extended by indicating new relationships between entities and/or datasets. For example, in an embodiment, using a user interface generated by user interface module 702, a user (e.g., a user of computing device 102a) may be enabled to indicate a relationship between at least one of a first entity (e.g., a data record or other data resource) and a second entity, between a third entity and dataset 114, or between dataset 114 and a second dataset maintained by data service 112. The relationship may be recorded in extensions table 706 by extension recorder 704.

In step 804, the first user is enabled to combine the first dataset and the second dataset. In one embodiment, datasets may be extended by combining datasets with other datasets into a single logical unit. For instance, one or more users may dislike how first and second datasets are compartmentalized, or may believe that a dataset is missing relevant dataset information. As such, in embodiments, users may be enabled to combine datasets together, and/or to extend a dataset with a table and/or other information to make a combined dataset that is more useful.

In an embodiment, a user (e.g., a user of computing device 102a) may be enabled to combine first and second datasets (and optionally further datasets) maintained by data service 112 using a user interface generated by user interface module 702. The combination may be recorded in extensions table 706 by extension recorder 704. The combinations may be exposed to users (e.g., made selectable to users in a user interface) so users can choose which logical unit fits their particular scenario. In an embodiment, a combination of datasets may be offered in a marketplace (as a new offering) to enable users to purchase the combination.

In embodiments, extension recorder 704 may record further information in extensions table 706 regarding extensions of datasets. For instance, in an embodiment, extension recorder 704 may track how many users created particular relationships. This tracked information may be exposed to users (e.g., in a user interface) to enable users to choose relationships that may function best for their particular scenarios. Furthermore, in an embodiment, extension recorder 704 may include an indication in extensions table 706 of how many users selected/chose a particular relationship combination (e.g., a percentage of users, a total number of users, etc.).

In step 806, a second user is enabled to comment on an extension to the first dataset. For example, in one embodiment, a second user may provide a comment on an extension to dataset 114 made by the first user (or other user) that is recorded in extensions table 706. In an embodiment, a user (e.g., a user of computing device 102a) may be enabled to input the comments to an extended dataset using a user interface generated by user interface module 702. The comment may be recorded in extensions table 706 by extension recorder 704.

For example, in an embodiment, users in the user community may be enabled to comment on extensions by rating extensions, voting on extensions, applying textual comments on extensions, and/or commenting on extensions in other ways. Through a user interface, users may be enabled to make extended databases available to other users of data service 112, and to apply identifying information to extensions, such as names or other identifiers, descriptions of the extensions, tags/keywords, and/or other identifying information so that other users may discover them. The users that discover extensions may be enabled to annotate the extensions, to extend the extensions, and/or to otherwise customize the discovered extensions, as described elsewhere herein.

### C. Example Embodiments for Providing Suggestions Regarding Datasets

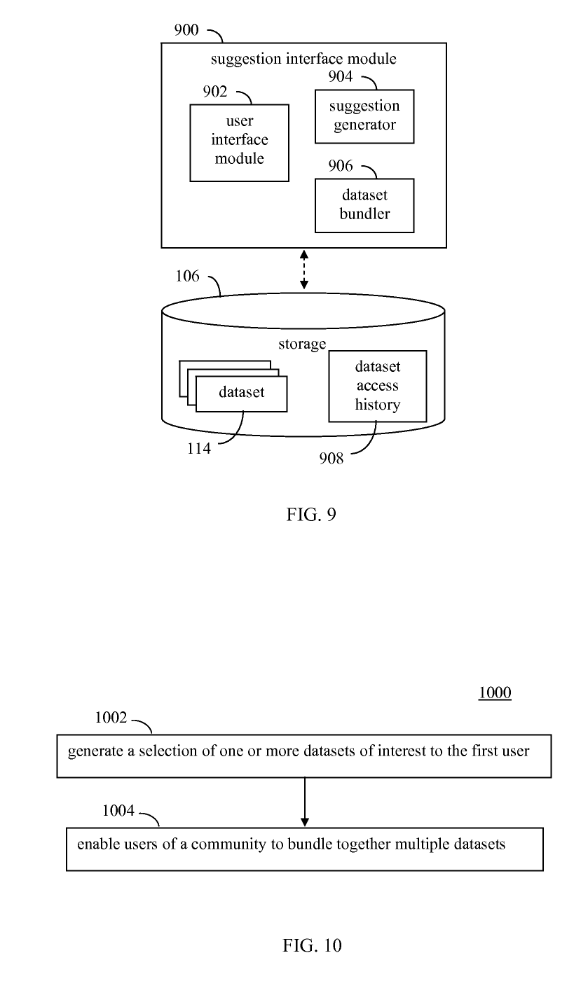

According to an example embodiment, datasets of a data service may be suggested to users. For instance, a dataset may be determined to be relevant to a user, and as a result, may be subsequently suggested to the user. FIG. 9 shows a block diagram of a suggestion interface module 900, according to an example embodiment. Suggestion interface module 900 is an example of suggestion interface module 206 of FIG. 2. As shown in FIG. 9, suggestion interface module 900 includes a user interface module 902, a suggestion generator 904, and a dataset bundler 906. Furthermore, suggestion interface module 900 is coupled to storage 106. Storage 106 stores a plurality of datasets, including dataset 114, and a dataset access history 908.

User interface module 902 is configured to generate a user interface that enables users to interact with suggestion interface module 900 to receive suggestions of datasets, such as dataset 114. An example of such a user interface is user interface 506 shown in FIG. 5 and described above, as well as other user interfaces described elsewhere herein. For instance, for a user that interacts with a dataset, suggestion generator 904 may generate suggestions of datasets to the user based on datasets that other users interacted with (e.g., a statistical measure). Suggestion generator 904 may access dataset access history 908 stored in storage 106, which indicates a history of dataset interactions by users. Dataset access history 908 may list the datasets available at the data service, and for each dataset, may list each user that interacted with the dataset. When a user interacts with a particular dataset, suggestion generator 904 may access dataset to determine which other users also accessed the dataset, and may recommend to the user other datasets accessed by the other users. Dataset bundler 906 is configured to enable users to bundle together different datasets as indicated by the users at the user interface generated by user interface module 902. For instance, dataset bundler 906 may enable users to bundle together datasets that users determined to be desirable to bundle together (e.g., that are related to each other, etc.). The dataset bundles may be indicated in dataset access history 908 by dataset bundler 906. Dataset access history 908 may be a file or other stored object that indicates datasets accessed by users and/or dataset bundles indicated by users. Dataset access history 908 may be a file or other object, and may contain information in the form of one or more tables, arrays, or other data structures.

Suggestion interface module 900 may operate in various ways to enable dataset suggestions to be provided. For instance, FIG. 10 shows a flowchart 1000 providing a process for enabling users to suggest datasets, according to an example embodiment. Flowchart 1000 may be performed by suggestion interface module 900 of FIG. 9, and may be performed during step 306 of flowchart 300 (FIG. 3), in an embodiment. Not all steps of flowchart 1000 need be performed in all embodiments. Further structural and operational embodiments will be apparent to persons skilled in the relevant art(s) based on the following discussion regarding flowchart 1000.

Flowchart 1000 begins with step 1002. In step 1002, a selection of one or more datasets of interest to the first user is generated. For example, as described above, suggestion generator 904 may generate a suggestion of one or more datasets for a user. A dataset may be suggested for a user based on the user's dataset viewing activities and the dataset viewing activities of other users, or may be suggested in other ways. The suggested datasets may be indicated to the user in the user interface generated by user interface module 902.

In step 1004, users of a community are enabled to bundle together multiple datasets. In one embodiment, datasets may be bundled with other datasets by users, to provide bundles of datasets that may be of interest to users. Such bundles may be suggestions of datasets that may fit together for various reasons. For instance, users may notice that particular datasets are similar and/or contain related information, and may be desired to be interacted with together. As such, in embodiments, users may be enabled to bundle such datasets together to create a dataset bundle.

In an embodiment, a user (e.g., a user of computing device 102a) may be enabled to bundle first and second datasets (and optionally further datasets) maintained by data service 112 using a user interface generated by user interface module 902. The user may be enabled to select multiple datasets, and to designate the selected datasets for a bundle. The bundle may be provided with a title and further descriptive information. The bundle may be recorded in dataset access history 908 by dataset bundler 906. The dataset bundles may be exposed to users (e.g., made selectable to users in a user interface) so users can interact with them. In an embodiment, a bundle of datasets may be offered in a marketplace (as a new offering) to enable users to purchase the bundle. Such bundles may be displayed to a user in various locations of a data service user interface, including being displayed adjacent to a dataset the user is interacting with, adjacent to a list of datasets that user has purchased, in a virtual “cart” that the user is composing for a current purchase, and/or in other location.

### D. Example Embodiments for Creating Derived Assets from Datasets

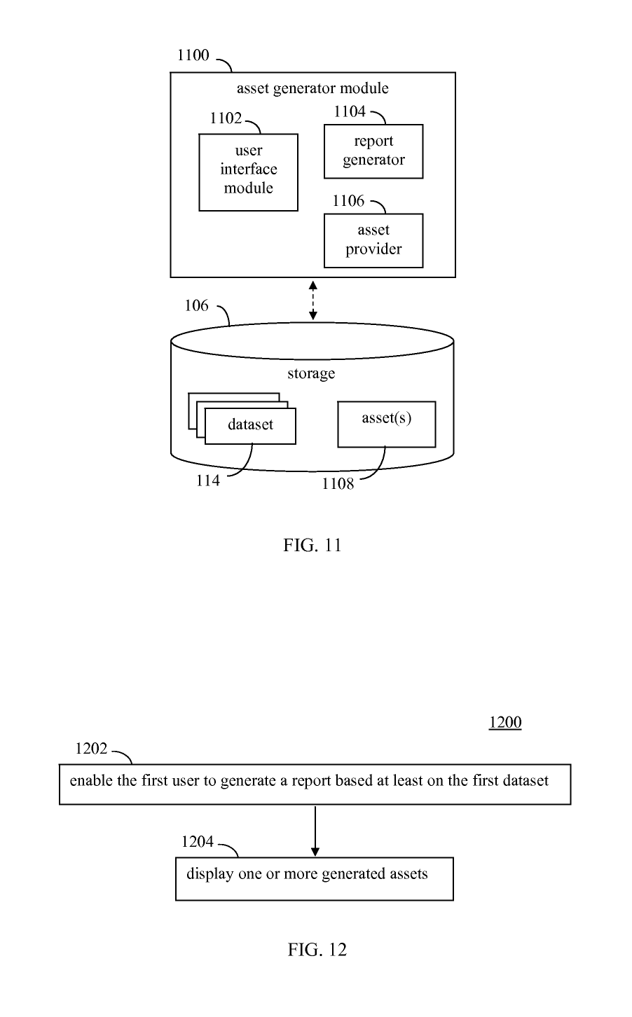

According to an example embodiment, users are enabled to generate assets, such as reports or applications, based on datasets of a data service. FIG. 11 shows a block diagram of an asset generator module 1100, according to an example embodiment. Asset generator module 1100 is an example of asset generator module 208 of FIG. 2. As shown in FIG. 11, asset generator module 1100 includes a user interface module 1102, a report generator 1104, and an asset provider 1106. Furthermore, asset generator module 1100 is coupled to storage 106. Storage 106 stores a plurality of datasets, including dataset 114, and one or more generated asset(s) 1108.

User interface module 1102 is configured to generate a user interface that enables users to interact with asset generator module 1100 to generate assets, such as asset(s) 1108, based on datasets such as dataset 114. An example of such a user interface is user interface 506 shown in FIG. 5 and described above, as well as other user interfaces described elsewhere herein. For instance, user interface module 1102 may generate a user interface that enables a user to interact with report generator 1104. The user may be enabled to select one or more datasets, and to generate an asset using report generator 1104. For instance, report generator 1104 may enable the user to generate a report, a visualization, and/or an application based on the one or more selected datasets. Report generator 1104 may be configured in any manner to generate assets. For instance, in an embodiment, report generator 1104 may invoke or include functionality of a word processing application (e.g., Microsoft® Word developed by Microsoft Corporation), a spreadsheet application (e.g., Microsoft Excel® developed by Microsoft Corporation), a presentation application (e.g., Microsoft® PowerPoint developed by Microsoft Corporation), or other application that enables a report or visualization to be generated. Still further, report generator 1104 may invoke or include functionality for generating an application, such as Microsoft® Visual Studio®, which is published by Microsoft Corporation of Redmond, Wash.

Asset provider 1106 is configured to provide generated assets for display. For instance, asset provider 106 may display an indication of a generated asset (e.g., a title, a description, etc.) in association with other datasets being displayed. In an embodiment, asset provider 1106 may compare one or more datasets that are being interacted with by a user of data service with asset(s) 1108 to determine any of asset(s) 1108 that are related to the datasets. Asset provider 1106 may display the determined assets to the user.

Asset generator module 1100 may operate in various ways to enable assets to be generated and displayed. For instance, FIG. 12 shows a flowchart 1200 providing a process for enabling users to generate assets based on datasets, according to an example embodiment. Flowchart 1200 may be performed by asset generator module 1100 of FIG. 11, and may be performed during step 308 of flowchart 300 (FIG. 3), in an embodiment. Not all steps of flowchart 1200 need be performed in all embodiments. Further structural and operational embodiments will be apparent to persons skilled in the relevant art(s) based on the following discussion regarding flowchart 1200.

Flowchart 1200 begins with step 1202. In step 1202, the first user is enabled to generate a report based at least on the first dataset. For example, as described above, report generator 1104 may enable a user to generate one or more assets based on one or more datasets stored in storage 106.

In step 1204, one or more generated assets are displayed. For instance, in an embodiment, asset provider 1106 may determine one or more assets related to a dataset being interacted with by a user. The determined asset(s) may be displayed to the user in the user interface generated by user interface module 1102. In this manner, derived assets may be shared with a user community. Such assets may be displayed to a user in various locations of a data service user interface, including being displayed adjacent to a dataset the user is interacting with, in a “gallery” section of the data service, and/or in other location.

As such, embodiments enable users to take datasets and/or derivative assets and use them as a starting point to which to add their own knowledge. Such derived assets may be used in various ways, including being fed back to the user community (e.g., posted in a marketplace), being sold to users through the data service marketplace, and being used in applications/reports. Furthermore, additional derivatives may be created based thereon.

### E. Example Embodiments for Sharing Datasets

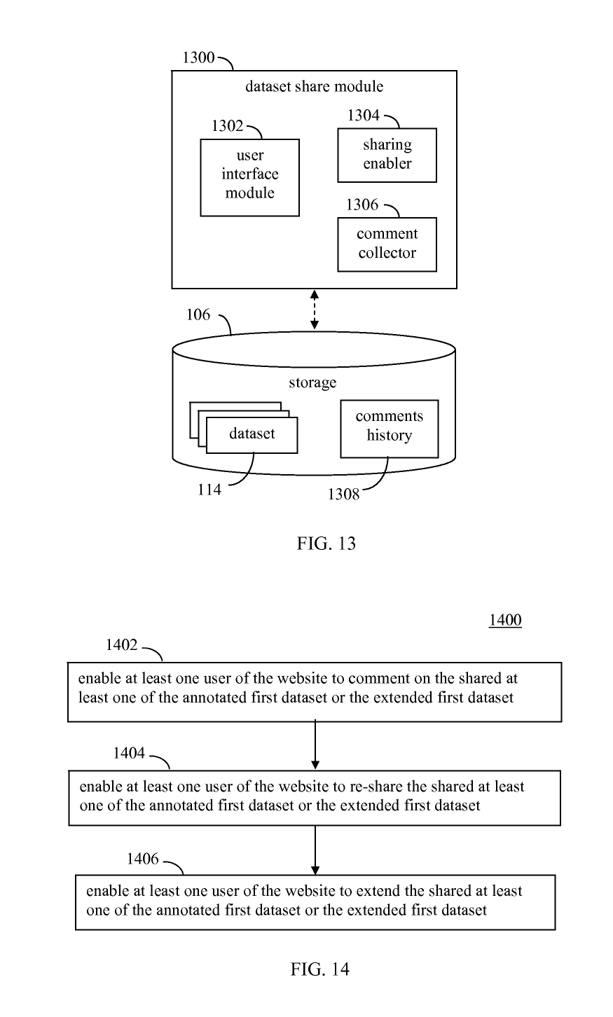

According to an example embodiment, users are enabled to share datasets of a data service. FIG. 13 shows a block diagram of a dataset share module 1300, according to an example embodiment. Dataset share module 1300 is an example of dataset share module 210 of FIG. 2. As shown in FIG. 13, dataset share module 1300 includes a user interface module 1302, a sharing enabler 1304, and a comment collector 1306. Furthermore, dataset share module 1300 is coupled to storage 106. Storage 106 stores a plurality of datasets, including dataset 114, and a comments history 1308.

User interface module 1302 is configured to generate a user interface that enables users to interact with dataset share module 1300 to share datasets, such as dataset 114, and to provide comments on shared datasets. An example of such a user interface is user interface 506 shown in FIG. 5 and described above, as well as other user interfaces described elsewhere herein. For instance, user interface module 1302 may generate a user interface that enables a user to interact with sharing enabler 1304. The user may be enabled to select one or more datasets, and to share the datasets, using sharing enabler 1304. For instance, sharing enabler 1304 may enable the user to post the selected datasets on a webpage of a website, such as a webpage of a social network, to share the selected datasets in an application, such as a desktop application, a web application, or other application, and/or to share the selected datasets on another device. Comment collector 1306 is configured to collect comments made by users on shared datasets. Comment collector 1306 may record/store the comments in comments history 1308. Comments history 1308 may be stored as a file or other object, and may include information in the form of one or more tables, arrays, or other data structure.

Dataset share module 1300 may operate in various ways to enable assets to be generated and displayed. For instance, FIG. 14 shows a flowchart 1400 providing a process for enabling users to share datasets, according to an example embodiment. Flowchart 1400 may be performed by dataset share module 1300 of FIG. 13, and may be performed during step 310 of flowchart 300 (FIG. 3), in an embodiment. Not all steps of flowchart 1400 need be performed in all embodiments. Furthermore, although step 310 and flowchart 1400 describe sharing datasets on websites, step 310 and flowchart 1400 may also be applied to sharing datasets in applications and devices. Further structural and operational embodiments will be apparent to persons skilled in the relevant art(s) based on the following discussion regarding flowchart 1400.

Flowchart 1400 begins with step 1402. In step 1402, at least one user of the website is enabled to comment on the shared at least one of the annotated first dataset or the extended first dataset. For example, as described above, comment collector 1306 may enable a user to share one or more datasets on a website, in an application, on another device, etc. Examples of websites include social networks, such as Facebook® operated by Facebook, Inc. of Palo Alto, Calif., Google+ operated by Google, Inc. of Mountain View, Calif., Twitter, Inc. of San Francisco, Calif., etc. Alternatively, comment collector 1306 may enable a user to share one or more datasets using other tools such as Microsoft SharePoint® and/or other enterprise IW (information worker) tools, by embedding a dataset in a website as a dynamic widget (e.g., a small website that can be embedded into other website), and/or according to other technique.

Such shared datasets may be datasets that were annotated as described above (e.g., with respect to dataset annotation modules 202 and 400) and/or were extended as described above (e.g., with respect to dataset extension modules 204 and 700). Comment collector 1306 may enable users to comment on a shared dataset at a website in any manner described herein or otherwise known, including providing textual comments, providing ratings, voting, liking/unliking, etc. The collected comments may be stored in comments history 1308. As such, embodiments provide an extensible embed framework that enables users to share their insights and annotations with a user community.

In step 1404, at least one user of the website is enabled to re-share the shared at least one of the annotated first dataset or the extended first dataset. For instance, in an embodiment, sharing enabler 1304 may enable a user of a website to re-share a shared dataset at the website as described above (e.g., by displaying on a user interface of a data service, by posting to a webpage, etc.).

In step 1406, at least one user of the website is enabled to extend the shared at least one of the annotated first dataset or the extended first dataset. For instance, in an embodiment, a user may be enabled to extend a dataset shared at a website in a manner as described elsewhere herein (e.g., with regard to dataset extension modules 204 and 700). A user may be enabled to open a shared dataset, may analyze any insights provided therein, and may extend the shared dataset with their own insights. The user may be enabled to post the extended dataset back into the data service marketplace, to share the extended dataset again (in the same or different location), etc. For instance, in one embodiment, a gallery of the dataset extensions may be provided.

### III Example Computing Device Embodiments

Data service 112, provider interface module 122, annotation and extension system 124, annotation and extension system 200, dataset annotation module 202, dataset extension module 204, suggestion interface module 206, asset generator module 208, dataset share module 210, dataset annotation module 400, user interface module 402, annotations recorder 404, dataset extension module 700, user interface module 702, extension recorder 704, suggestion interface module 900, user interface module 902, suggestion generator 904, dataset bundler 906, asset generator module 1100, user interface module 1102, report generator 1104, asset provider 1106, user interface module 1302, sharing enabler 1304, comment collector 1306, flowchart 300, flowchart 600, flowchart 800, flowchart 1000, flowchart 1200, and flowchart 1400 may be implemented in hardware, software, firmware, or any combination thereof, including being implemented as computer program code configured to be executed in one or more processors, and/or being implemented as hardware logic/electrical circuitry. For instance, in an embodiment, one or more of data service 112, provider interface module 122, annotation and extension system 124, annotation and extension system 200, dataset annotation module 202, dataset extension module 204, suggestion interface module 206, asset generator module 208, dataset share module 210, dataset annotation module 400, user interface module 402, annotations recorder 404, dataset extension module 700, user interface module 702, extension recorder 704, suggestion interface module 900, user interface module 902, suggestion generator 904, dataset bundler 906, asset generator module 1100, user interface module 1102, report generator 1104, asset provider 1106, user interface module 1302, sharing enabler 1304, comment collector 1306, flowchart 300, flowchart 600, flowchart 800, flowchart 1000, flowchart 1200, and/or flowchart 1400 may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

As described above, annotation and extension systems 124 and 200 may generate one or more user interfaces (e.g., user interface 506). The user interface may enable user input to be provided from one or more of any type of user interface elements provided by a computing device, including a keyboard, a thumb wheel, a pointing device, a roller ball, a stick pointer, a touch sensitive display, any number of virtual interface elements, a voice recognition system, etc.

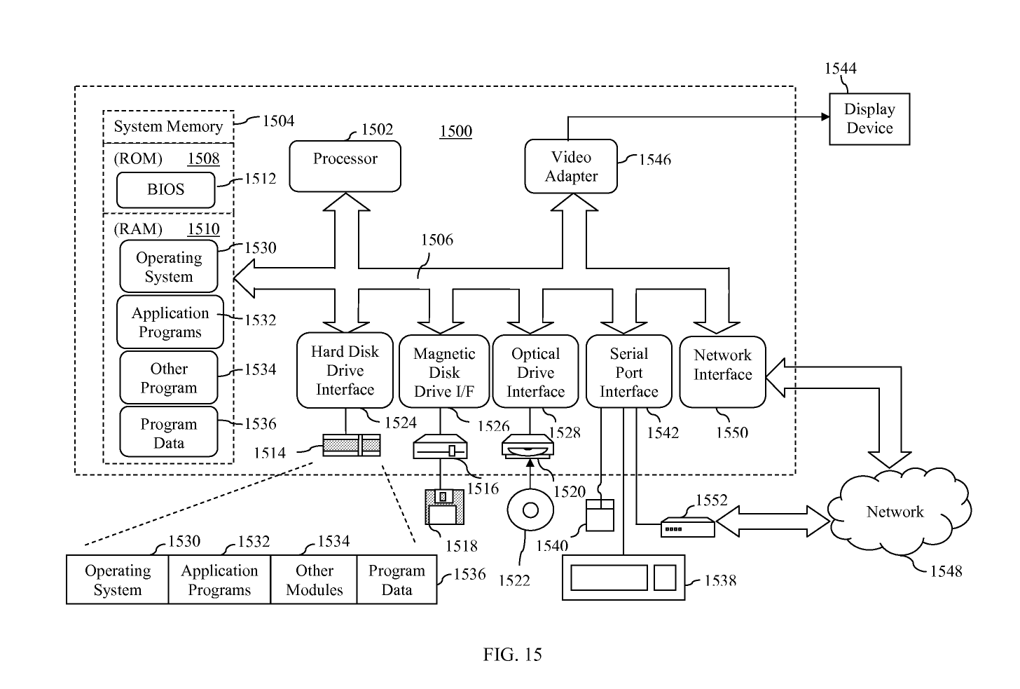

FIG. 15 depicts an exemplary implementation of a computer 1500 in which embodiments of the present invention may be implemented. For example, computing devices 102a, 102b, and 116, and/or server 104 may be implemented in a computer system similar to computer 1500, including one or more features of computer 1500 and/or alternative features. Computer 1500 may be a general-purpose computing device in the form of a conventional personal computer, a mobile computer, a server, or a workstation, for example, or computer 1500 may be a special purpose computing device. The description of computer 1500 provided herein is provided for purposes of illustration, and is not intended to be limiting. Embodiments of the present invention may be implemented in further types of computer systems, as would be known to persons skilled in the relevant art(s).

As shown in FIG. 15, computer 1500 includes one or more processors 1502, a system memory 1504, and a bus 1506 that couples various system components including system memory 1504 to processor 1502. Bus 1506 represents one or more of any of several types of bus structures, including a memory bus or memory controller, a peripheral bus, an accelerated graphics port, and a processor or local bus using any of a variety of bus architectures. System memory 1504 includes read only memory (ROM) 1508 and random access memory (RAM) 1510. A basic input/output system 1512 (BIOS) is stored in ROM 1508.

Computer 1500 also has one or more of the following drives: a hard disk drive 1514 for reading from and writing to a hard disk, a magnetic disk drive 1516 for reading from or writing to a removable magnetic disk 1518, and an optical disk drive 1520 for reading from or writing to a removable optical disk 1522 such as a CD ROM, DVD ROM, or other optical media. Hard disk drive 1514, magnetic disk drive 1516, and optical disk drive 1520 are connected to bus 1506 by a hard disk drive interface 1524, a magnetic disk drive interface 1526, and an optical drive interface 1528, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1530, one or more application programs 1532, other program modules 1534, and program data 1536. Application programs 1532 or program modules 1534 may include, for example, computer program logic (e.g., computer program code/instructions) for implementing data service 112, provider interface module 122, annotation and extension system 124, annotation and extension system 200, dataset annotation module 202, dataset extension module 204, suggestion interface module 206, asset generator module 208, dataset share module 210, dataset annotation module 400, user interface module 402, annotations recorder 404, dataset extension module 700, user interface module 702, extension recorder 704, suggestion interface module 900, user interface module 902, suggestion generator 904, dataset bundler 906, asset generator module 1100, user interface module 1102, report generator 1104, asset provider 1106, user interface module 1302, sharing enabler 1304, comment collector 1306, flowchart 300, flowchart 600, flowchart 800, flowchart 1000, flowchart 1200, and/or flowchart 1400 (including any step of flowcharts 300, 400, 800, 1000, 1200, and 1400), and/or further embodiments described herein.

A user may enter commands and information into the computer 1500 through input devices such as keyboard 1538 and pointing device 1540. Other input devices (not shown) may include a microphone, joystick, game pad, satellite dish, scanner, or the like. These and other input devices are often connected to processor 1502 through a serial port interface 1542 that is coupled to bus 1506, but may be connected by other interfaces, such as a parallel port, game port, or a universal serial bus (USB).

A display device 1544 is also connected to bus 1506 via an interface, such as a video adapter 1546. In addition to the monitor, computer 1500 may include other peripheral output devices (not shown) such as speakers and printers.

Computer 1500 is connected to a network 1548 (e.g., the Internet) through an adaptor or network interface 1550, a modem 1552, or other means for establishing communications over the network. Modem 1552, which may be internal or external, is connected to bus 1506 via serial port interface 1542.

As used herein, the terms “computer program medium,” “computer-readable medium,” and “computer-readable storage medium” are used to generally refer to media such as the hard disk associated with hard disk drive 1514, removable magnetic disk 1518, removable optical disk 1522, as well as other media such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1532 and other program modules 1534) may be stored on the hard disk, magnetic disk, optical disk, ROM, or RAM. Such computer programs may also be received via network interface 1550 or serial port interface 1542. Such computer programs, when executed or loaded by an application, enable computer 1500 to implement features of embodiments of the present invention discussed herein. Accordingly, such computer programs represent controllers of the computer 1500.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method in a data service that maintains data for providers to publish and share with users, comprising:
enabling a first user to annotate a first dataset maintained by the data service;
enabling the first user to extend the first dataset; and
generating a suggestion of a second dataset to the first user based on information received from a community of users.

2. The method of claim 1, wherein said enabling a first user to annotate a first dataset maintained by the data service comprises:
enabling the first user to annotate at least one of a table of the first dataset, a field of the first dataset, or a relationship associated with the first dataset; and
enabling the first user to comment on an annotation to the first dataset provided by a second user.

3. The method of claim 1, wherein said enabling the first user to extend the first dataset comprises:
enabling the first user to indicate a relationship between at least one of a first entity and a second entity, a third entity and the first dataset, or the first dataset and a second dataset maintained by the data service;
enabling the first user to combine the first dataset and the second dataset; and
enabling a second user to comment on an extension to the first dataset.

4. The method of claim 1, further comprising:
enabling the first user to generate an asset based at least on the first dataset.

5. The method of claim 4, wherein said enabling the first user to generate an asset based at least on the first dataset comprises:
enabling the first user to generate a report based at least on the first dataset; and
displaying one or more generated assets

6. The method of claim 1, further comprising:
enabling the first user to share at least one of the annotated first dataset or the extended first dataset in at least one of a website, an application, or a device.

7. The method of claim 6, wherein said enabling the first user to share at least one of the annotated first dataset or the extended first dataset in at least one of a website, an application, or a device comprises:
enabling at least one user of the website, the application, or the device to comment on the shared at least one of the annotated first dataset or the extended first dataset;
enabling at least one user of the website, the application, or the device to re-share the shared at least one of the annotated first dataset or the extended first dataset; and
enabling at least one user of the website, the application, or the device to extend the shared at least one of the annotated first dataset or the extended first dataset.

8. A server that includes a data service, the server comprising:
a provider interface module that enables content providers to provide datasets to be maintained by the data service, to be published and shared with users by the data service; and
an annotation and extension system that enables a community of users to annotate and extend the datasets maintained by the data service, the annotation and extension system including
a dataset annotation module that enables a first user to annotate a first dataset maintained by the data service,
a dataset extension module that enables the first user to extend the first dataset, and
a suggestion interface module that generates a suggestion of a second dataset to the first user based on information received from a community of users.

9. The system of claim 8, wherein the dataset annotation module comprises:
an annotations recorder that records annotations made by the first user to at least one of a table of the first dataset, a field of the first dataset, or a relationship associated with the first dataset, and records comments made by the first user on an annotation to the first dataset provided by a second user.

10. The system of claim 8, wherein the dataset extension module comprises:
an extension recorder that records a relationship indicated by the first user between at least one of a first entity and a second entity, a third entity and the first dataset, or the first dataset and a second dataset maintained by the data service;
the extension recorder records a combination made by the first user of the first dataset and the second dataset; and
the extension recorder records a comment on an extension to the first dataset provided by the first user.

11. The system of claim 8, wherein the annotation and extension system further comprises:
an asset generator module that enables the first user to generate an asset based at least on the first dataset.

12. The system of claim 11, wherein the asset generator module comprises:
a report generator that enables the first user to generate a report based at least on the first dataset; and
an asset provider that enables one or more generated assets to be displayed.

13. The system of claim 8, wherein the annotation and extension system further comprises:
a dataset share module that enables the first user to share at least one of the annotated first dataset or the extended first dataset in at least one of a website, an application, or a device.

14. The system of claim 13, wherein the dataset share module comprises:
a sharing enabler that enables the first user to share at least one of the annotated first dataset or the extended first dataset on the at least one of the website, the application, or the device; and
a comment collector that receives a comment on the shared at least one of the annotated first dataset or the extended first dataset from at least one user of the website, the application, or the device;
the sharing enabler enables at least one user of the website, the application, or the device to re-share the shared at least one of the annotated first dataset or the extended first dataset; and
the dataset extension module enables at least one user of the website, the application, or the device to extend the shared at least one of the annotated first dataset or the extended first dataset.

15. A computer readable storage medium having computer program instructions embodied in said computer readable storage medium for enabling a processor to manage datasets of a data service, the computer program instructions comprising:
first computer program instructions that enable the processor to enable a first user to annotate a first dataset maintained by the data service;
second computer program instructions that enable the processor to enable the first user to extend the first dataset; and
third computer program instructions that enable the processor to generate a suggestion of a second dataset to the first user based on information received from a community of users.

16. The computer readable storage medium of claim 15, wherein said first computer program instructions comprise:
fourth computer program instructions that enable the first user to annotate at least one of a table of the first dataset, a field of the first dataset, or a relationship associated with the first dataset; and
fifth computer program instructions that enable the first user to comment on an annotation to the first dataset provided by a second user.

17. The computer readable storage medium of claim 15, wherein said second computer program instructions comprise:
fourth computer program instructions that enable the first user to indicate a relationship between at least one of a first entity and a second entity, a third entity and the first dataset, or the first dataset and a second dataset maintained by the data service;
fifth computer program instructions that enable the first user to combine the first dataset and the second dataset; and
sixth computer program instructions that enable a second user to comment on an extension to the first dataset.

18. The computer readable storage medium of claim 15, the computer program instructions further comprising:
fourth computer program instructions that enable the first user to generate an asset based at least on the first dataset.

19. The computer readable storage medium of claim 15, the computer program instructions further comprising:
fourth computer program instructions that enable the first user to share at least one of the annotated first dataset or the extended first dataset in at least one of a website, an application, or a device.

20. The computer readable storage medium of claim 19, wherein said fourth computer program instructions comprise:
fifth computer program instructions that enable at least one user of the website, the application, or the device to comment on the shared at least one of the annotated first dataset or the extended first dataset;
sixth computer program instructions that enable at least one user of the website, the application, or the device to re-share the shared at least one of the annotated first dataset or the extended first dataset; and
seventh computer program instructions that enable at least one user of the website, the application, or the device to extend the shared at least one of the annotated first dataset or the extended first dataset.
